(19) United States
(12) Patent Application Publication
(10) Pub. No.: US 2018/0198099 A1
(43) Pub. Date: Jul. 12, 2018

(54) ANTI-EXPLOSIVE EASY-TO-DISSEMBLE SAFE ADHESIVE TAPE AND MANUFACTURING METHOD THEREOF

(71) Applicant: Shenzhen Meixin Electronics Co., Ltd., Shenzhen (CN)

(72) Inventors: Weibin Chen, Shenzhen (CN); Zhou Li, Shenzhen (CN); Xuehao Lin, Shenzhen (CN)

(21) Appl. No.: 15/848,511

(22) Filed: Dec. 20, 2017

Related U.S. Application Data
(63) Continuation of application No. PCT/CN2017/093660, filed on Jul. 20, 2017.

(30) Foreign Application Priority Data
Jan. 12, 2017 (CN) 201710019729.7

(51) Int. Cl. H01M 2/02; C09K 5/14; C09J 7/38; C09J 9/00; C09J 9/02; C09J 11/04; C09J 11/08; B32B 7/12; B32B 7/02; B32B 27/28; B32B 27/24; B32B 27/32; B32B 37/12

(52) U.S. Cl. CPC H01M 2/0267; C09J 157/06; C09J 7/38; C09J 9/00; C09J 9/02; C09J 11/04; C09J 11/08; B32B 7/12; B32B 7/02; B32B 27/283; B32B 27/24; B32B 27/325; B32B 37/12; H01M 2/0277; H01M 2/0285; H01M 2/0287; C09K 5/14

(57) ABSTRACT

The invention discloses an anti-explosive easy-to-disassemble safe adhesive tape and a manufacturing method thereof. The adhesive tape comprises a flame-retardant, current-conducting, heat-conducting and heat-expansion pressure-sensitive adhesive layer, a flame-retardant, current-conducting, heat-conducting and extensible viscosity-losing layer, a flame-retardant, current-conducting, heat-conducting and heat-expansion pressure-sensitive adhesive layer, and a release material layer which are overlapped in sequence. By adopting the adhesive tape disclosed in the invention, a plurality of battery packs can be combined together to increase the capacity or voltage. If an automobile encounters a collision, the material of the adhesive tape is collided and heated, and then expands instantly in order to effectively separate each battery module, and avoid greater damage.

### CROSS-REFERENCE TO RELATED PATENT APPLICATION

This application is a continuation application of International Patent Application No. PCT/CN2017/093660, filed on Jul. 20, 2017, which itself claims priority to Chinese Patent Application No. CN201710019729.7, filed in China on Jan. 12, 2017. The disclosures of the above applications are incorporated herein in their entireties by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to the technical field of adhesive tape, and more particularly, to an adhesive tape with a power battery pack and a manufacturing method thereof. The adhesive tape conducts heat and current at a normal state and expands by heating to extend to lose viscosity at a special state.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

China's new energy vehicle industry has a vigorous development, with sales volume increasing rapidly and industrialization accelerating constantly.

With respect to the new energy, the power battery is used as a power tool to provide the power source. That is to say, the power battery mostly means an accumulator that provides the power for electric vehicles, electric trains, electric bicycles, and golf carts, which is mainly different from a starting battery for starting a vehicle engine. Compared with the fuel-powered vehicle, the key of the safety issue of the power vehicle is the safety of the power battery, especially, after the vehicle collision, how to avoid damage caused by the explosion of the battery.

The power battery is connected by a plurality of single batteries with power cell in parallel-series. The capacity is increased in parallel, while the voltage remains unchanged. The voltage is redoubled in series, while the capacity remains unchanged. For example, the 3.6V/10 Ah battery is composed by single N18650/2 Ah in 5-parallel, the 36V/2 Ah battery can be composed by single N18650/2 Ah in 10-series, and the 36V/10 Ah battery is composed by single N18650/2 Ah in 5-parallel and 10-series.

The battery combination is achieved by two ways. One is nickel strip spot welding or laser welding or ultrasonic welding, which is a common means that has the advantage of better reliability but is not easy to replace. The other is flexible metal sheet contact, which has the advantage of no welding, is relatively easy to replace the battery, and has the disadvantage of causing bad contact possibly. During the combination process, the battery pack is required to meet working hour requirement, environmental requirement, vibration requirement, charging requirement, life requirement, etc. The battery pack cannot be used separately (over-charge, over-discharge and over-current will damage the battery), and needs to be equipped with a special protective plate before use. The protective plate can play a role in over-charge protection, over-discharge protection, and short-circuit protection, etc.

If the plurality of battery packs is combined together by an adhesive material, the capacity or voltage will be increased. In normal use, the adhesive material can play the role of connection, flame retardant, heat dissipation and grounding. When a part of the battery module is repaired, its release force performance loses viscosity by changing the elongation of the adhesive material, so as to separate the battery module well. If an automobile encounters a collision, the material of the adhesive tape is collided and heated, and then expands instantly in order to effectively separate the battery module, and avoid greater damage.

### SUMMARY

In order to solve the technical problems of bad contact or inconvenient replace of the current power battery pack, the present invention provide an anti-explosive easy-to-disassemble safe adhesive tape dedicated for the power battery pack and a manufacturing method thereof.

The invention provides an anti-explosive easy-to-disassemble safe adhesive tape, comprising a flame-retardant, current-conducting, heat-conducting and heat-expansion pressure-sensitive adhesive layer, a flame-retardant, current-conducting, heat-conducting and extensible viscosity-losing layer, a flame-retardant, current-conducting, heat-conducting and heat-expansion pressure-sensitive adhesive layer, and a release material layer which are overlapped in sequence. The flame-retardant, current-conducting, heat-conducting and heat-expansion pressure-sensitive adhesive layer is prepared by the following raw materials in percentage by weight:

37.5-62.5% organic polymer matrix, 22.5-55.5% tackifying resin, 0.5-15.0% flame retardant, 0.5-12.5% heat-conducting material, 0.5-12.5% current-conducting material, and 1.0-17.5% heat-expansion microparticle.

The invention further provides a manufacturing method of the anti-explosive easy-to-disassemble safe adhesive tape, comprising the following steps of:

step 1. weighing up organic polymer matrix, tackifying resin, flame retardant, heat-conducting filler, current-conducting filler and heat-expansion microparticle in the proportion of formula and mixing, stirring completely and uniformly, then obtaining heat-conducting, current-conducting and current-conducting, heat-conducting and heat-expansion pressure-sensitive adhesive solution;

step 2. coating the pressure-sensitive solution on the release material, baking through an over at 80-150° C., drying completely to obtain the release material having the flame-retardant, current-conducting, heat-conducting and heat-expansion pressure-sensitive adhesive layer, and rolling up;

step 3. coating flame-retardant, current-conducting, heat-conducting and extensible viscosity-losing solution on another release material, baking through the over at 80-15° C., drying completely to obtain the release material having the flame-retardant, current-conducting, heat-conducting and extensible viscosity-losing solution layer, and re-rolling up;

or, performing step 2 and step 3 synchronously, or firstly preparing the release material having the flame-retardant, current-conducting, heat-conducting and extensible viscosity-losing layer, and then preparing the release material having the flame-retardant, current-conducting, heat-conducting and heat-expansion pressure-sensitive adhesive layer;

step 4. on a re-rolling laminating machine, loosening the material roll of the release material having the first flame-retardant, current-conducting, heat-conducting and heat-expansion pressure-sensitive adhesive layer and the material roll of the release material having the flame-retardant, current-conducting, heat-conducting and extensible viscosity-losing layer, sticking the two adhesive surfaces together, and peeling off the release material of the lame-retardant, current-conducting, heat-conducting and extensible viscosity-losing layer; and

step 5. sticking the adhesive surface of the flame-retardant, current-conducting, heat-conducting and extensible viscosity-losing layer in the combined material and the other roller of release material having the flame-retardant, current-conducting, heat-conducting and heat-expansion pressure-sensitive adhesive layer together, then obtaining the adhesive tape combining with the flame-retardant, current-conducting, heat-conducting and heat-expansion pressure-sensitive adhesive layer at two sides of the flame-retardant, current-conducting, heat-conducting and extensible viscosity-losing layer.

The present invention is the self-created anti-explosive easy-to-disassemble high-molecule sticking chemical adhesive tape dedicated for battery pack and a manufacturing method thereof. The adhesive tape can combine a plurality of battery packs together easily to increase the capacity or voltage. In normal use, the adhesive tape can play the role of connection, flame retardant, heat dissipation and grounding. But when a part of the battery module is repaired, its release force performance loses viscosity by changing the elongation of the adhesive tape material, so as to separate the battery module well. In addition, if an automobile encounters a collision, the material of the adhesive tape is collided and heated, and then expands instantly in order to effectively separate each battery module, and avoid greater damage.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a schematic cross section of the embodiment of an anti-explosive easy-to-disassemble safe adhesive tape of the present invention.

### DETAILED DESCRIPTION

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

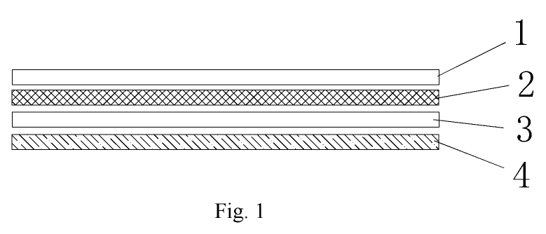

As shown in FIG. 1, the embodiment of the invention provides an anti-explosive easy-to-disassemble safe adhesive tape, comprising a flame-retardant, current-conducting, heat-conducting and heat-expansion pressure-sensitive adhesive layer 1, a flame-retardant, current-conducting, heat-conducting and extensible viscosity-losing layer 2, a flame-retardant, current-conducting, heat-conducting and heat-expansion pressure-sensitive adhesive layer 3, and a release material layer 4 which are overlapped in sequence.

Wherein, the flame-retardant, current-conducting, heat-conducting and heat-expansion pressure-sensitive adhesive layer is prepared by the following raw materials in percentage by weight:

37.5-62.5% organic polymer matrix, 22.5-55.5% tackifying resin, 0.5-15.0% flame retardant, 0.5-12.5% heat-conducting material, 0.5-12.5% current-conducting material, and 1.0-17.5% heat-expansion microparticle.

According to different requirements, the formula of the different pressure-sensitive adhesive layers can be selected.

TABLE 1

| | Formula | | | | |
|---|---|---|---|---|---|
| Raw material | A | B | C | D | E |
| Organic polymer matrix | 37.5 | 50.0 | 62.5 | 38.0 | 40.0 |
| Tackifying resin | 55.5 | 39.0 | 22.5 | 23.0 | 25.0 |
| Flame retardant | 0.5 | 8.0 | 1.0 | 15.0 | 3.0 |
| Heat-conducting material | 0.5 | 1.0 | 6.5 | 12.5 | 2.0 |
| Current-conducting material | 0.5 | 1.0 | 6.5 | 2.5 | 12.5 |
| Heat-expansion microparticle | 5.5 | 1.0 | 1.0 | 9.0 | 17.5 |

In the present invention, the organic polymer matrix may be compounded by natural rubber or synthetic rubber, which has good initial viscosity and is suitable for materials having low surface and being difficult to stick. Moreover, acrylic resin or organo-siloxane resin can be selected as the organic polymer matrix of the pressure-sensitive material. The tackifying resin may be petroleum resin, rosin resin, terpene resin, or one of the modified resins of petroleum resin, rosin resin and terpene resin. The flame retardant can be selected from non-halogen phosphorus flame retardant. The heat-conducting filler can be selected from metal particles, such as aluminum oxide, silver, copper and other metal powder, or one of graphite, graphene material and other non-metallic heat-conducting materials. The current-conducting material can be selected from one of conductive particles such as silver-coated copper powder, copper powder, nickel powder or current-conducting graphite powder and other current-conducting particles. The heat-expansion microparticle can be made of hydrocarbon-coated high-molecular polymer, such as acrylonitrile, acrylonitrile copolymer or other acrylonitrile copolymer or vinylidene chloride.

The flame-retardant, current-conducting, heat-conducting and heat-expansion pressure-sensitive adhesive layer of the invention is prepared by taking an organic polymer as a matrix, adding a flame retardant, a heat-conducting filler, current-conducting particles and meeting heat-expansion microparticle. At the normal state, the pressure-sensitive adhesive layer can play the role of sticking, flame retardant, heat dissipation and grounding. In special cases, if encountering the collision, the sticking material is collided and heated, and then expands instantly in order to effectively separate each stuck material.

The flame-retardant, current-conducting, heat-conducting and extensible viscosity-losing layer is composed of a special modified rubber, which has the characteristics of high sticking strength, impact resistance and drop resistance, and can meet the vibration requirements that may be encountered when a powered vehicle travels on the road.

The invention provides a manufacturing method of the anti-explosive easy-to-disassemble safe adhesive tape, comprising the following steps of:

Step 1. According to the need, the formula proportion (referring to the formula of the pressure-sensitive adhesive layer—table 1) of the anti-explosive easy-to-disassemble safe adhesive tape is selected. The raw materials, including organic polymer matrix, tackifying resin, flame retardant, heat-conducting filler, current-conducting filler and heat-expansion microparticle, are weighed up. The raw materials are mixed, and stirred completely and uniformly, so as to prevent the flame retardant, heat-conducting filler, current-conducting filler and heat-expansion filler from settling and agglomerating to obtain a uniformly-mixed heat-conducting, current-conducting and heat-expansion pressure-sensitive adhesive solution. At this point, the heat conductivity coefficient is increased to 1.0 W/m·K from the traditional 0.1 W/m·K or below. At the same time, the heat-expansion functional particles used in the adhesive layer manufactured by the pressure-sensitive solution can have good compatibility with the flame retardant, the heat-conducting and current-conducting material and the adhesive.

Step 2. According to the viscosity and solid content of the pressure-sensitive adhesive solution obtained in the above step 1 and the thickness of the dried adhesive layer obtained according to the need, the suitable coating method is selected, such as roll coating, scraping knife or scraping stick coating. The release material having the flame-retardant, current-conducting, heat-conducting and heat-expansion pressure-sensitive adhesive layer is obtained by coating the pressure-sensitive solution on the release material, baking through an over at 80-150° C., and drying completely, and rolled up. According to the need, the material roll of the release material having the pressure-sensitive adhesive layer.

Step 3. The flame-retardant, current-conducting, heat-conducting and extensible viscosity-losing solution is coated on another release material, baked through the over at 80-150° C., dried completely to obtain the release material having the flame-retardant, current-conducting, heat-conducting and extensible viscosity-losing layer, and re-rolled up. According to the need, the material rolls of the release material have the extensible viscosity-losing layer.

The step 2 and step 3 can be performed synchronously, or the release material having the flame-retardant, current-conducting, heat-conducting and extensible viscosity-losing layer is firstly prepared, and then the release material having the flame-retardant, current-conducting, heat-conducting and heat-expansion pressure-sensitive adhesive layer is prepared.

Step 4. on a re-rolling laminating machine, the material roll of the release material having the first flame-retardant, current-conducting, heat-conducting and heat-expansion pressure-sensitive adhesive layer and the material roll of the release material having the flame-retardant, current-conducting, heat-conducting and extensible viscosity-losing layer are loosened respectively, the two adhesive surfaces are stuck together, and the release material of the lame-retardant, current-conducting, heat-conducting and extensible viscosity-losing layer is peeled off.

Step 5. The adhesive surface of the flame-retardant, current-conducting, heat-conducting and extensible viscosity-losing layer in the combined material and the other roller of release material having the flame-retardant, current-conducting, heat-conducting and heat-expansion pressure-sensitive adhesive layer are stuck together to obtain the adhesive tape combining with the flame-retardant, current-conducting, heat-conducting and heat-expansion pressure-sensitive adhesive layer at two sides of the flame-retardant, current-conducting, heat-conducting and extensible viscosity-losing layer.

The current-conducting particles used in the pressure-sensitive adhesive layer make the adhesive tape have the conductive grounding function, and the resistance in the XY and Z directions can reach below 0.1 ohm. Flame-retardant, current-conducting, heat-conducting and heat-expansion pressure-sensitive adhesive layer has a thickness of 3-150 μm to ensure sufficient adhesive property, flame retardant, current-conducting property and heat-conducting property. If the pressure-sensitive adhesive layer thickness is too thin, the sticking ability is relatively poor, which cannot guarantee the effective sticking of the battery in the case of vibration; at the same time, the pressure-sensitive adhesive layer is too thin, it may make the pressure-sensitive adhesive layer and the stuck heating element, such as element cell not be fully contacted, an air layer exists in the middle, so that the heat conducting effect is greatly reduced. If the thickness of the pressure-sensitive adhesive layer is too thick, excessive glue at high temperature and high thermal resistance may occur although the adhesion between the element cells can be improved. In the pressure-sensitive adhesive layer, the heat-expansion functional particles are used, and the heat-expansion functional particles can be well compatible with the selected pressure-sensitive adhesive body and the heat-conducting and current-conducting particles. However, in the event of an accident such as a collision, for example, when the temperature reaches about 200° C., the pressure-sensitive adhesive layer instantly expands and the 180° peel strength decreases to below 1 N/cm, thereby separating each battery module.

The heat-expansion microparticles in the pressure-sensitive adhesive layer can rapidly expand in 3˜6 s at a certain temperature, which can accomplish viscosity-losing to separate the battery pack and short circuit of the battery. The expansion pressure-resisting strength of the heat-expansion microparticles can reach 150-300 Psi.

The flame-retardant, current-conducting, heat-conducting and extensible viscosity-losing layer is composed of a special modified rubber whose thickness is controlled between 5-300 μm so as to have the characteristics of high sticking strength, impact resistance and drop resistance. When the extensible viscosity-losing adhesive layer has the rearrangement of molecular chain under the action of tension, the rigidity (storage modulus) increases, and the pressure-sensitive property weakens, which shows worse adhesive property (peeling force property) macroscopically, or even loses or completely loses the viscosity. Thereof, the stuck object will be separated well and no pressure-sensitive adhesive is left on the surface of the stuck object, which is beneficial to reclaiming the separated single battery.

In the invention, the stretchable synthetic rubber is used as the base material of the whole adhesive tape. Due to the relatively low tensile strength, when the battery pack needs to be disassembled, only the base material needs to be stretched so as to very easily drive the heat-conducting and current-conducting pressure-sensitive adhesive layers on both sides, so as to lose the viscosity due to the stretch. For example, when the stretch ratio is 50% or more, the 180° peel strength can be promptly decreased to 1 N/m or below to separate the adjacent element cells.

According to the industrial test, the technical indicators of the product achievable by the present invention are as follows:

1. The flame-retardant, current-conducting, heat-conducting and heat-expansion pressure-sensitive adhesive: the material is acrylic glue containing functional particles (heat-conducting particles and expandable particles), the 180° peel strength of SUS304 is 10 N/cm or more, the temperature resistance is greater than 110° C., 70° C. high temperature static shear force is greater than 72 h, and the heat conductivity coefficient is greater than 1.0 W/mK.

2. The flame-retardant, current-conducting, heat-conducting and extensible viscosity-losing layer: the material is the flame-retardant, current-conducting, heat-conducting synthetic rubber with modified tensile strength, and the heat conductivity coefficient is greater than 1.0 W/m·K, and the stretching rate is greater than 50%.

3. The performance indicator of the adhesive tape: the thickness is 0.15-0.30 mm; the flame retardant property passes through the UL94V-0 standard; the 180° peel force of SUS304 at room temperature is above 10 N/cm; 70° C. high temperature static shear force is greater than 72 h; the conductivity is at 0.1 ohm or below; the heat conductivity coefficient in the XY direction is at least 1.0 W/mK; 180° peel strength is 1.0 W/m·K or above; the elongation is 50% or more; the 180° peel strength is 1 N/cm or below; the temperature is above 200° C., the 180° peel strength is 1 N/cm or below.

4. It can exist in the roll-like form.

5. Environmental requirement: meet RoHS and halogen-free directives.

The above detailed description only describes preferable embodiments of the present utility model, and is not intended to limit the patent scope of the present utility model, so any equivalent technical changes made by use of the specification of the creation and the content shown in the drawings fall within the patent scope of the creation.

What is claimed is:

1. An anti-explosive easy-to-disassemble safe adhesive tape, comprising a flame-retardant, current-conducting, heat-conducting and heat-expansion pressure-sensitive adhesive layer (1), a flame-retardant, current-conducting, heat-conducting and extensible viscosity-losing layer (2), a flame-retardant, current-conducting, heat-conducting and heat-expansion pressure-sensitive adhesive layer (3), and a release material layer (4) which are overlapped in sequence.

2. The anti-explosive easy-to-disassemble safe adhesive tape according to claim 1, wherein the flame-retardant, current-conducting, heat-conducting and heat-expansion pressure-sensitive adhesive layer is prepared by the following raw materials in percentage by weight:
37.5-62.5% organic polymer matrix, 22.5-55.5% tackifying resin, 0.5-15.0% flame retardant, 0.5-12.5% heat-conducting material, 0.5-12.5% current-conducting material, and 1.0-17.5% heat-expansion microparticle.

3. The anti-explosive easy-to-disassemble safe adhesive tape according to claim 2, wherein the organic polymer matrix is one of an acrylic resin, a material compounded by natural rubber or synthetic rubber, or organosiloxane resin material.

4. The anti-explosive easy-to-disassemble safe adhesive tape according to claim 2, wherein the tackifying resin is one of petroleum resin, rosin resin, terpene resin or modified resin of petroleum resin, rosin resin and terpene resin.

5. The anti-explosive easy-to-disassemble safe adhesive tape according to claim 2, wherein the flame retardant is halogen-free phosphorus flame retardant.

6. The anti-explosive easy-to-disassemble safe adhesive tape according to claim 2, wherein the heat-conducting material is one of metallic grains, graphite and graphene material.

7. The anti-explosive easy-to-disassemble safe adhesive tape according to claim 2, wherein the current-conducting material is one of silver-coated copper powder, copper powder, nickel powder or current-conducting graphite powder.

8. The anti-explosive easy-to-disassemble safe adhesive tape according to claim 2, wherein the heat-expansion microparticle is hydrocarbon-packaged high-molecular polymer.

9. A manufacturing method of the anti-explosive easy-to-disassemble safe adhesive tape according to claim 1, comprising the following steps of:
step 1. weighing up organic polymer matrix, tackifying resin, flame retardant, heat-conducting filler, current-conducting filler and heat-expansion microparticle in the proportion of formula and mixing, stirring completely and uniformly, then obtaining heat-conducting, current-conducting and current-conducting, heat-conducting and heat-expansion pressure-sensitive adhesive solution;
step 2. coating the pressure-sensitive solution on the release material, baking through an over at 80-150° C., drying completely to obtain the release material having the flame-retardant, current-conducting, heat-conducting and heat-expansion pressure-sensitive adhesive layer, and rolling up;
step 3. coating flame-retardant, current-conducting, heat-conducting and extensible viscosity-losing solution on another release material, baking through the over at 80-150° C., drying completely to obtain the release material having the flame-retardant, current-conducting, heat-conducting and extensible viscosity-losing solution layer, and re-rolling up;
or, performing step 2 and step 3 synchronously, or firstly preparing the release material having the flame-retardant, current-conducting, heat-conducting and extensible viscosity-losing layer, and then preparing the release material having the flame-retardant, current-conducting, heat-conducting and heat-expansion pressure-sensitive adhesive layer;
step 4. on a re-rolling laminating machine, loosening the material roll of the release material having the first flame-retardant, current-conducting, heat-conducting and heat-expansion pressure-sensitive adhesive layer and the material roll of the release material having the flame-retardant, current-conducting, heat-conducting and extensible viscosity-losing layer, sticking the two adhesive surfaces together, and peeling off the release material of the lame-retardant, current-conducting, heat-conducting and extensible viscosity-losing layer; and
step 5. sticking the adhesive surface of the flame-retardant, current-conducting, heat-conducting and extensible viscosity-losing layer in the combined material and the other roller of release material having the flame-retardant, current-conducting, heat-conducting and heat-expansion pressure-sensitive adhesive layer together, then obtaining the adhesive tape combining with the flame-retardant, current-conducting, heat-conducting and heat-expansion pressure-sensitive adhesive layer at two sides of the flame-retardant, current-conducting, heat-conducting and extensible viscosity-losing layer.

10. The manufacturing method according to claim 9, wherein the flame-retardant, current-conducting, heat-conducting and heat-expansion pressure-sensitive adhesive layer is in a thickness of 3-150 μm, and the expansion compressive strength of the heat-expansion microparticle can reach 150-300 Psi.

11. A manufacturing method of the anti-explosive easy-to-disassemble safe adhesive tape according to claim 2, comprising the following steps of:
step 1. weighing up organic polymer matrix, tackifying resin, flame retardant, heat-conducting filler, current-conducting filler and heat-expansion microparticle in the proportion of formula and mixing, stirring completely and uniformly, then obtaining heat-conducting, current-conducting and current-conducting, heat-conducting and heat-expansion pressure-sensitive adhesive solution;
step 2. coating the pressure-sensitive solution on the release material, baking through an over at 80-150° C., drying completely to obtain the release material having the flame-retardant, current-conducting, heat-conducting and heat-expansion pressure-sensitive adhesive layer, and rolling up;
step 3. coating flame-retardant, current-conducting, heat-conducting and extensible viscosity-losing solution on another release material, baking through the over at 80-150° C., drying completely to obtain the release material having the flame-retardant, current-conducting, heat-conducting and extensible viscosity-losing solution layer, and re-rolling up;
or, performing step 2 and step 3 synchronously, or firstly preparing the release material having the flame-retardant, current-conducting, heat-conducting and extensible viscosity-losing layer, and then preparing the release material having the flame-retardant, current-conducting, heat-conducting and heat-expansion pressure-sensitive adhesive layer;
step 4. on a re-rolling laminating machine, loosening the material roll of the release material having the first flame-retardant, current-conducting, heat-conducting and heat-expansion pressure-sensitive adhesive layer and the material roll of the release material having the flame-retardant, current-conducting, heat-conducting and extensible viscosity-losing layer, sticking the two adhesive surfaces together, and peeling off the release material of the lame-retardant, current-conducting, heat-conducting and extensible viscosity-losing layer; and
step 5. sticking the adhesive surface of the flame-retardant, current-conducting, heat-conducting and extensible viscosity-losing layer in the combined material and the other roller of release material having the flame-retardant, current-conducting, heat-conducting and heat-expansion pressure-sensitive adhesive layer together, then obtaining the adhesive tape combining with the flame-retardant, current-conducting, heat-conducting and heat-expansion pressure-sensitive adhesive layer at two sides of the flame-retardant, current-conducting, heat-conducting and extensible viscosity-losing layer.

12. The manufacturing method according to claim 11, wherein the flame-retardant, current-conducting, heat-conducting and heat-expansion pressure-sensitive adhesive layer is in a thickness of 3-150 μm, and the expansion compressive strength of the heat-expansion microparticle can reach 150-300 Psi.
